(19) United States
(12) Patent Application Publication
(10) Pub. No.: US 2021/0137776 A1
(43) Pub. Date: May 13, 2021

(54) MASSAGE ROLLER AND HOOK APPARATUS

(71) Applicants: Richard Davis, Owasso, OK (US); Charles Caswell, Tulsa, OK (US)

(72) Inventors: Richard Davis, Owasso, OK (US); Charles Caswell, Tulsa, OK (US)

(21) Appl. No.: 17/096,897

(22) Filed: Nov. 12, 2020

Related U.S. Application Data
(60) Provisional application No. 62/934,388, filed on Nov. 12, 2019.

(51) Int. Cl. A61H 15/00

(52) U.S. Cl. CPC A61H 15/0092; A61H 2201/1635; A61H 2015/0064

(57) ABSTRACT

A generally “S” shaped massage roller and hook apparatus that is designed to be a handheld portable massage device to provide a user the ability to reach areas of the body that are typically hard to reach, as well as normal areas in need of massage. The massage roller and hook apparatus of the present invention provides multiple types of massage therapy and generally comprises a centrally located spindle having two ends, a massage roller centrally mounted on the spindle in a rotatable engagement, two ball bearing units that create said rotatable engagement, a small hook section connected on one end of the spindle, a large hook section connected on the apposite end of the spindle and containing a handle for leverage, two roller ball end knobs to provide a massage that simulates thumbs or fingers for a deep massage, and a fixed end knob located at the end of the handle for an even deeper tissue massage. The centrally located massage roller portion provides a rolling, kneading type of massage to sore muscles all over the user's body.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

The present invention relates generally to massage devices used to massage one's own body and more particularly to a hand held portable massage device used to reach hard to reach areas of the body and also provide rolling massage therapy to a user's body.

Massage therapy has long been used as a method to treat tight, stiff, and injured muscles and to soothe or eliminate muscle and joint pains, or simply to relax and refresh a person. Massage provides many benefits including prevention, prediction, and healing of muscle injuries, improvement of strength, flexibility, and endurance, dispersal of lactic acid, and acceleration of recovery. Athletes, exercise aficionados, just your normal everyday person have long turned to massage to improve performance, ease aching muscles and relieve stress. Use of a licensed massage therapist might be most beneficial, but is likely prohibitively expensive to most people. Therefore, personal hand held massage devices have been developed to address these needs.

Different types of hand held massage devices have been developed to address different needs and/or provide a different type of massage therapy. Massage devices to allow a user to provide trigger point therapy to parts of the body that could not otherwise be reached have been developed. Many of these prior art devices typically come in some form of “hook” design. Further, massage roller devices and massage bars have been developed to aid a user in providing massage to certain muscles of the body by rolling the device over a muscle. While some of the prior art devices may be beneficial, they do not provide a user with a full massage therapy option.

Each of the prior art devices only allow a user to provide one type of massage therapy and are therefore limited in the effectiveness. Therefore, a need exists for an improved portable massage device that provides a user multiple types of massage therapy in a single device.

### SUMMARY

The present invention is directed to a new and novel massage device that combines multiple types of massage therapy to allow a user to massage hard to reach areas of the body and also provide rolling massage therapy to a user's muscles for a total body massage. This combination overcomes the disadvantages found in the prior art.

The present invention overcomes the drawbacks and disadvantages found in the prior art by providing a sort of “multi-tool” massage device. In a preferred embodiment of the present invention, the massage device provides a small hook portion with roller-ball end knob to help reach areas like shoulders, calves, and feet, a large hook portion with roller-ball end knob to help reach areas like back, glues, and hamstrings, and a small end knob for tight deep tissue knot release. The small end knob also doubles as a finger grip handle to provide massaging leverage for the user. The massage device further incorporates a rolling massage bar in the middle of the device to provide a rolling, kneading massage for sore muscles and trigger points for a total body massage. The roller-ball end knob portions simulate massaging thumbs or fingers for a deeper more relieving massage.

The invention generally takes the form of an S-shaped massager with a handle that sticks out of the S-shape to provide for leverage while massaging. Generally, the massage device contains different areas of finger grips to aide in grasping while a user massages their sore muscles.

It is an object of the present invention to provide roller type therapy with the trigger point therapy by incorporating a roller ball into the end of the hook portion of the invention.

It is also a further object of the present invention to provide trigger point therapy without the roller ball at the end knobs so that the end of the hook portion is simply a fixed end.

While it is to be understood that both the foregoing general description and the following detailed description are exemplary and explanatory only and are not restrictive on the present invention, these and other features, aspects, and advantages of the present invention will become better understood with regard to the following detailed description and accompanying drawings where:

### BRIEF DESCRIPTION OF THE DRAWINGS

FIG. 1 is an isometric view of a preferred embodiment of the present invention;

FIG. 2 is a first side view of the embodiment shown in FIG. 1;

FIG. 3 is a second side view of the embodiment shown in FIG. 1;

FIG. 4 is an end view of the embodiment as shown in FIG. 2;

FIG. 5 is an end view of the embodiment as shown in FIG. 3;

FIG. 6 is a top view of the embodiment as shown in FIGS. 1 and 2;

FIG. 7 is a bottom view of the embodiment as shown in FIGS. 1 and 2;

FIG. 8 is an isometric view of the preferred embodiment as shown in FIG. 1 in use on the lower back;

FIG. 9 is an isometric view of the preferred embodiment as shown in FIG. 1 in use on the neck;

FIG. 10 is an isometric view of the preferred embodiment as shown in FIG. 1 in use on the quadriceps;

FIG. 11 is an isometric view of the preferred embodiment as shown in FIG. 1 in use on the trapezius and upper back;

FIG. 12 is an isometric view of the preferred embodiment as shown in FIG. 1 in use on the calves;

FIG. 13 is an exploded view of the preferred embodiment shown in FIG. 1.

### DESCRIPTION

Referring now to the drawings, reference will be made to the preferred embodiment of the invention, an example of which is illustrated in the accompanying drawings, in which like reference numerals refer to like parts throughout. With reference to FIGS. 1, 2 and 3, a preferred embodiment of the present invention is shown. A massage roller and hook apparatus 1 is shown having a massage roller portion 10 centrally located on the massage roller and hook apparatus 1. The overall shape of the present invention 1 is generally “S”-shaped with the addition of a handle 4. The “S”-shaped portion can be said to consist of a large hook portion 2 and a small hook portion 3. Roller-ball end knobs 6 are located at the end of both the large hook 2 and small hook 3. Located along the central axis close to the small hook 3 and also on the handle 4 are finger-grip handle portions 7 that aide a user while using by allowing them to gain leverage while providing massage relief. The handle 4 also contains a small fixed end 5 for deep tissue knot release or massage.

Now with reference to FIG. 13, which is an exploded view of the preferred embodiment of the present invention, reference can be made to more components of the massage roller and hook apparatus 1. Shown therein is a centrally located spindle 12 upon which all other components are attached. The massage roller 10 is mounted over the spindle 12 for rotatable engagement thereon. This rotatable engagement is accomplished via ball bearing units 9 also mounted over the spindle 12. Both the small hook 3 and the large hook 2 are mounted onto the spindle and locked into place via two screws 11; the large hook 2 containing the handle 4. Lastly, the roller-ball end knobs 6 are attached to the hook portions of the present invention by being fit into a recessed portion 13 located at end of both hooks and affixed via an internally threaded cap 8 which mates with the externally threaded portion 14 of the hook portions 2 and 3.

FIGS. 8 through 12 depict various uses of the massage roller and hook apparatus 1. FIGS. 8, 9, and 10 specifically depict the use of the massage roller bar 10 of the present invention being used on the lower back and obliques, the neck, and quadriceps. The massage roller bar 10 being rotatably connected to the overall device 1 is simply used by rolling the bar 10 over the muscles in need of massage therapy. The face of the massage roller bar 10 contains a specific relief providing design to provide rolling massage kneading and trigger-points of sore muscles. While the preferred embodiment of the massage roller bar 10 contains a specific pattern to knead sore muscles and trigger points for a total body massage, it is contemplated that many different patterns may be an object of the present invention depending on the type of massage therapy needed or desired.

In FIGS. 11 and 12, it is shown how the roller-ball end knobs 6 are used to massage and knead the muscles of the user. Specifically, in FIG. 11, the user is using the roller-ball end knob 6 of the large hook 2 to massage the trapezius and upper back muscles. While doing so, it is apparent where the importance of the handle 4 and the finger-grip handle portions 7 come into play in aiding the user to gain leverage and sufficient grip. In FIG. 12, a user is depicted using the roller-ball end knob 6 of the small hook 3 to massage the calves. The massage roller 10 could also be used for massaging the calves, but is not depicted in these figures. Further, these figures depicting some uses of the massage roller and hook apparatus 1 are only a small number of the massage exercises that can be performed by the present invention.

For instance, the large hook 2 is ideally used to help reach hard to reach areas like the back, glutes, and hamstrings. The small hook 3 can be used for areas such as the shoulders, calves, and feet. However, the present invention was developed for users to use the different beneficial massaging components as they feel comfortable.

In another embodiment of the present invention, the use of the roller-ball end knobs 6 may be discontinued in favor of a fixed end 5 such as that found at the end of the handle 4.

The hook and handle portions of the present invention are preferably made out of a hard plastic material that can withstand the forces necessary for the device to work correctly. The massage roller 10 is also made out of a plastic material but one that is more of a pliable material or softer material so that it is comfortable to the user when rolling on one's muscles.

Various changes, alternatives and modifications may become apparent to one of ordinary skill in the art following a reading of the foregoing specification. It is intended that any such changes, alternatives, and modifications within the scope of the appended claims be considered a part of the present invention. Further, it is within the ambit of the present invention to cover any obvious modifications of the preferred embodiment described herein.

What is claimed is:

1. A massage roller and hook apparatus comprising:
a centrally located spindle with two ends;
a massage roller centrally mounted on said spindle in a rotatable engagement;
two ball bearing units mounted on said spindle and fitting into the ends of the massage roller thereby creating said rotatable engagement;
a small hook section connected to one end of the spindle;
a large hook section connected to the other end of the spindle, wherein said large hook section contains a handle;
two roller ball end knobs located at the ends of the small hook section and the large hook section; and
a fixed end knob located at the end of the handle contained on the large hook section.

2. The massage roller and hook apparatus of claim 1, wherein the small hook portion and large hook portion are connected to the opposite ends of the spindle via a plurality of screws.

3. The massage roller and hook apparatus of claim 1, wherein the two roller ball end knobs located at the ends of the small and large hook sections are connected thereto by being fit into a recessed section located at the ends of the small and large hook sections and are affixed thereto via an internally threaded cap which mates with an externally threaded portion of the small and large hook sections.

4. The massage roller and hook apparatus of claim 1, wherein a finger grip design element is located on the handle and on the small hook section.

5. The massage roller and hook apparatus of claim 1, wherein the overall shape of the massage roller and hook apparatus is generally “S” shaped.

6. A massage roller and hook apparatus comprising:
a centrally located spindle with two ends;
a massage roller centrally mounted on said spindle in a rotatable engagement;
two ball bearing units mounted on said spindle and fitting into the ends of the massage roller thereby creating said rotatable engagement;
a small hook section connected to one end of the spindle;
a large hook section connected to the other end of the spindle, wherein said large hook section contains a handle;
two fixed end knobs located at the ends of the small hook section and the large hook section; and
a fixed end knob located at the end of the handle contained on the large hook section.

7. The massage roller and hook apparatus of claim 6, wherein the small hook portion and large hook portion are connected to the opposite ends of the spindle via a plurality of screws.

8. The massage roller and hook apparatus of claim 6, wherein a finger grip design element is located on the handle and on the small hook section.

9. The massage roller and hook apparatus of claim 6, wherein the overall shape of the massage roller and hook apparatus is generally “S” shaped.
